(19) United States
(12) Patent Application Publication
(10) Pub. No.: US 2009/0120894 A1
(43) Pub. Date: May 14, 2009

(54) Multifunctional bottle cap

(76) Inventors: Berna Kario, Elmwood Park, NJ (US); Haluk Hannavi, Lodi, NJ (US); Dani I. Kario, Elmwood Park, NJ (US)

Correspondence Address: Berna E. Kario, 133 Summit Ave, Elmwood Park, NJ, 07407, US

(21) Appl. No.: 11/983,593

(22) Filed: Nov. 9, 2007

(51) Int. Cl. B65D 41/04; A61J 11/00; B65D 47/06; B65D 83/00; B65D 23/00

(52) U.S. Cl. 215/11.1; 215/229; 215/387; 215/389

(57) ABSTRACT

A multifunctional drinking bottle cap for attachment to a plurality of different sized bottle neck diameters includes a base member, a drinking mechanism attachment accommodation for a drinking mechanism selected from a flexible nipple, a spout and a straw. The base member has a dispensing orifice that extends from top to bottom for dispensing a liquid from a bottle. The bottom of the base member has a plurality of concentric threaded orifice sections with sequentially decreasing diameters when measured from the bottom to the top, and the top has an attachment ring collar connection, such as a screw thread, snap fit connector, bayonet connector or other similar connector. There is a drinking mechanism selected from the group consisting of a flexible nipple, a spout and a straw that partially engages the aforesaid drinking mechanism attachment accommodation of the base member. The attachment ring collar is adapted to fit over the drinking mechanism and to attach it to the base member.

### BACKGROUND OF INVENTION

a. Field of Invention

The invention relates generally to a multifunctional bottle cap that is modular and adapts to different neck sizes and to different thread diameters so as to accommodate different drinkable products, such as milk containers, juice containers, soda containers and water containers. The cap may have a dispensing mechanism that could be a spout, a nipple or a straw.

b. Description of Related Art

The following patents are representative of a log in system:

United States Patent Application No. 2007/0095778 to Morris Catton describes a nipple adapter including a nipple having a first outer sealing flange and a second outer sealing flange, and a cylindrical nipple housing. The nipple housing includes an inner annular wall that defines a bore extending axially through the housing, an annular flange disposed on the inner annular wall, a first thread extending from the annular flange to a first axial end of the nipple housing, and a second thread extending from the annular flange to a second axial end of the nipple housing, the first thread having a pitch that differs from that of the second thread. The nipple is reversibly disposed within the nipple housing such that the annular flange is disposed between the first and second outer sealing flanges and the first and second threads are alternatively exposed for mating with corresponding threads of a variety of water bottles.

U.S. Pat. No. 7,210,602 to Tom Blanchester describes a multifunctional bottle cap is disclosed, which includes a cap body having a lower portion with internal threads for connecting to a neck of a bottle, and an upper portion having an upwardly protruding nozzle with an outlet opening at an edge portion of the nozzle with an outlet opening at an edge portion of the nozzle; a straw having an upper end extending out of the protruding nozzle adjacent to the outlet opening, the straw being vertically moveable to extend upward from the cap body; and a spray assembly having a press pumping mechanism, an aspiration tube, a pump button extending upwardly, and a spray nozzle in perpendicular to a longitudinal axis of the cap body; the spray pump being positioned on an opposing side of the protruding nozzle. The multifunctional bottle cap provides a user the ability to drink, spray and pour liquid from an attached bottle.

U.S. Pat. No. 6,851,565 B2 to Gerard Stephan describes an annular adapter adapts a standard beverage bottle, such as a plastic water bottle, to accommodate the internal threads of a baby's annular nipple cap, which has a nipple inserted therein. Inside the annular adapter is a seal, such as a disc-shaped annular ledge extending in a plane perpendicular to the axis of the adapter, to prevent leakage, when a baby bottle nipple and cap are inserted over the exterior threads of the annular adapter. Liquid flows through the central opening of the annular adapter. The nipple is inserted and the seal engages the bottle of the water bottle, the annular adapter is screwed over a conventional threaded exterior neck of a standard beverage bottle, such as a water bottle.

U.S. Pat. No. 6,415,937 B1 to Lorraine DeJonge et al describes a bottle adapter for securing an attachment to a bottle. The attachment can be a nipple and ring assembly for a baby bottle. The bottle adapter has a base, and the base has a bottom end and a top end. A bottle receiving portion extends from the bottom end of the base, and an attachment receiving portion extends from the top end of the base. The bottle receiving portion includes an outer bottle receiving ring and an inner bottle receiving ring. The attachment receiving portion includes an outer attachment receiving ring and an inner attachment receiving ring. The base of the bottle adapter also includes a passage defined therein for allowing the flow of a fluid from the bottle receiving portion to the attachment receiving portion of the bottle adapter. In an embodiment of the invention, the bottle adapter is sized to adapt both a disposable liner bottle nipple and ring assembly and a traditional nipple and ring assembly.

U.S. Pat. No. 6,112,926 to Gary Fisherman describes a non-closable device with no movable parts which fits on to twist top beverage bottles reducing the size of the opening and flow of liquid from the bottle. The piece in itself consists entirely of molded plastic. Threading on the interior of the base cylinder enables the unit to be screwed on to the bottle. A spout member with slotted aperture enables liquid to flow through the device at a decreased volume and rate. The piece is screwed onto a beverage bottle and the user drinks through the spout member via the slotted aperture. The piece makes drinking from twist top beverage bottles easier for toddlers and/or people who have difficulty drinking from common beverage bottles, and for people in general who simply prefer a more regulated flow and contoured spout.

U.S. Pat. No. 6,089,389 to Igal Sharon et al describes a container holding two separate components, which are mixed prior to use is provided. The container comprises a housing defining a first compartment having a sealable opening and a neck portion between said first compartment and said opening. The container further comprises a displaceable member which is disposed within the housing which has a partition wall an edge for sealing engagement with the internal wall of the neck portion, thereby defining a second compartment sealed from the first compartment and being in flow communication with the opening. The displaceable member is axially displaceable between two positions along an axis extending through the neck portion. These two positions comprise a first position where the edge of the partition wall sealably engages the internal walls of the neck portion, and a second position where the edge of the partition wall and the internal walls of the neck portion are disengaged, permitting flow communication between the two compartments. The container with two components is prepared by first introducing a first component into the first compartment, placing the displacable member within the compartment and fitting it into said first position, introducing the second compartment and sealing the opening.

U.S. Pat. No. 5,105,956 to Horng Tarng-Lin describes a nursing bottle having a nipple to be connected with an extension hose. It includes a nipple that is able to be connected with an extension hose and extend through a fixing component and a bottle cap into the bottle. A grip jaw is provided on the fixing component which will be contracted in a reception trough or hole on the top of the bottle while the fixing component is screwed on the bottle cap to tightly grip the extension hose. The length of the extension hose is able to be adjusted to extend out of the bottle to facilitate the nursing bottle to be used in offering the nipple to the baby or child for sucking and placing the at a distance and without the need of the nurser or the baby or child having to hold the bottle.

Notwithstanding the prior art, the present invention is neither taught nor rendered obvious thereby.

### SUMMARY OF INVENTION

The present invention is a multifunctional drinking bottle cap for attachment to a plurality of different sized bottle neck diameters. It includes a base member, a drinking mechanism attachment accommodation selected from a flexible nipple connection means, a spout connection means, and a straw connection means. These drinking mechanism attachment accommodations may be recesses, bosses, guide holes, tabs or any other alignment and connection mechanism.

The base member has a top and a bottom and at least one side wall. The base member also has a dispensing orifice that extends from top to bottom for dispensing a liquid from a bottle. The bottom of the base member has a plurality of concentric threaded orifice sections with sequentially decreasing diameters when measured from the bottom to the top, and the top has an attachment ring collar connection means, such as a screw thread, snap fit connector, bayonet connector or other similar means. There is a drinking mechanism selected from the group consisting of a flexible nipple, a spout and a straw that partially engages the aforesaid drinking mechanism attachment accommodation of the base member. There is also an attachment ring collar adaptable to fit over the drinking mechanism and to attach it to the attachment means for secured connection thereof to the base member.

In some preferred embodiments of the present invention multifunctional drinking bottle cap, the attachment ring collar connection means is a threaded circular boss on the top of the base member and the attachment ring collar has complementary internal threads.

In some preferred embodiments of the present invention multifunctional drinking bottle cap, the attachment ring collar connection means is a snap-on connection means adapted to receive the attachment collar ring by snap fit thereto.

In some preferred embodiments of the present invention multifunctional drinking bottle cap, the base member has two concentric threaded orifice sections.

In some preferred embodiments of the present invention multifunctional drinking bottle cap, the base member has at least three concentric threaded orifice sections.

In some preferred embodiments of the present invention multifunctional drinking bottle cap, the base member and the attachment ring collar are made of plastic material.

In some preferred embodiments of the present invention multifunctional drinking bottle cap, there is a flexible nipple drinking mechanism.

In some preferred embodiments of the present invention multifunctional drinking bottle cap, there is a spout drinking mechanism.

In some preferred embodiments of the present invention multifunctional drinking bottle cap, there is a straw drinking mechanism.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front exploded cut view of one embodiment of the present invention multifunctional bottle cap illustrating three different size inside diameters to accommodate three different size caps, and including a baby bottle nipple;

FIG. 2 is a front exploded cut view of one embodiment of the present invention multifunctional bottle cap illustrating three different size inside diameters to accommodate three different size caps, and including a drinking spout dispenser;

FIG. 3 is a front exploded cut view of one embodiment of the present invention multifunctional bottle cap illustrating three different size inside diameters to accommodate three different size caps, and including a straw;

FIG. 4 is a front exploded cut view of one embodiment of the present invention multifunctional bottle cap illustrating four different size inside diameters to accommodate three different size caps, and including a baby bottle nipple;

FIG. 5 is a front exploded cut view of one embodiment of the present invention device illustrating four different inside diameters having a spout dispenser and adapted for different diameter threaded beverage container necks;

FIG. 6 is a side cut view of one embodiment of the present invention device illustrating four different inside diameters having a straw dispenser and adapted for different diameter threaded beverage container necks; and,

FIG. 7 is a front exploded cut view of one embodiment of the present invention device illustrating four different inside diameters having a spout dispenser and adapted for different diameter threaded beverage container necks. This embodiment is similar to the FIG. 5 embodiment, except that the ring collar screws onto the outside of the main housing.

### DETAILED DESCRIPTION OF THE EMBODIMENTS

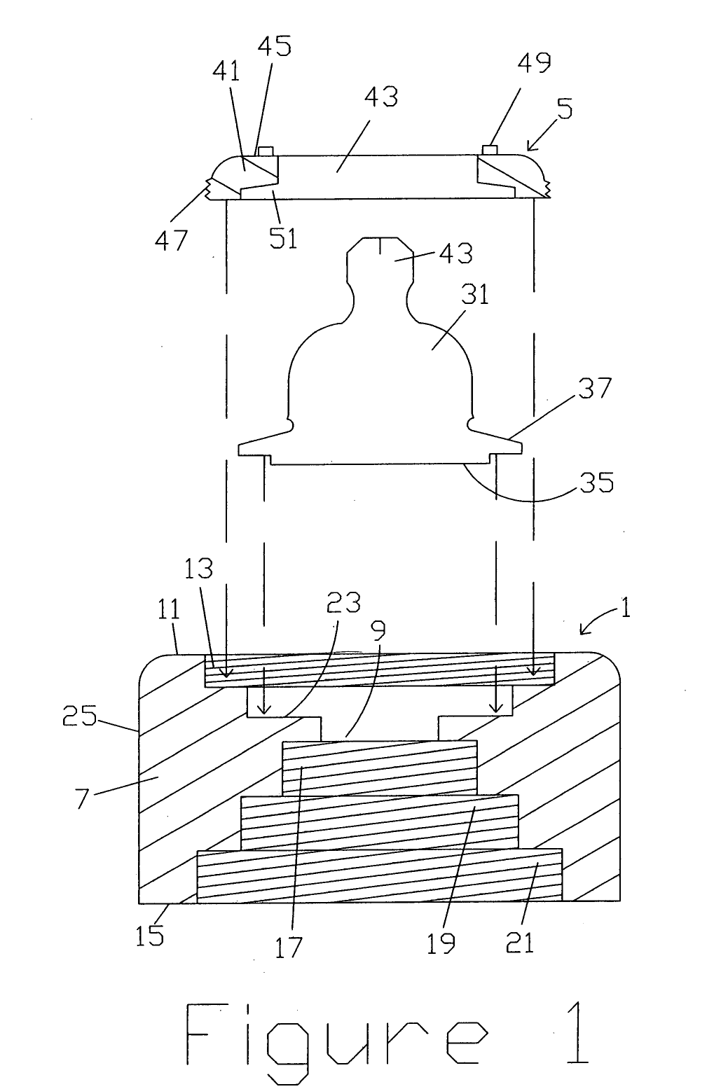

FIG. 1 is a front exploded cut view of one embodiment of the present invention multifunctional bottle cap 1 that includes a base member 7, a flexible baby bottle nipple 3 and an attachment ring collar 5. The base member 7 has a top 11, a bottom 15 and a sidewall 25, as shown. It is circular in external shape, but could have any desired external shape. Its top 11 includes a threaded upper recess 13 adapted to mate with ring collar 5. Top 11 also includes a lower recess 23 adapted to receive flexible nipple 3. Base member 7 also has a dispensing orifice 9 that extends downwardly through bottom 15 and upwardly through the aforesaid recesses. Base member 7 has three different size threaded inside diameters in its bottom 15 to accommodate three different size caps, and hence, has smallest diameter 17 furthest away from bottom 15, midsize diameter 19 next, followed by largest diameter 21 closest to bottom 15. By this arrangement, cap 1 may be attached to different size bottles and used for feeding a baby such liquids as containerized milk, water, juice, fruit drinks, fortified liquids and the like, without transferring contents to a baby bottle.

Attachment ring collar 5 has a central orifice 43 passing therethrough, threads 47 on outside wall 41 that screw into the corresponding receiving threads at recess 13 of base member 7. Tabs such as tab 49 on ring collar top 45 facilitate screwing and unscrewing thereof relative to base member 7. The flexible baby bottle-type nipple 3 has a main hollow body 31 with slitted dispensing end 33, and it has a flange 37. Nipple bottom 35 nests in recess 23 of base member 7, ring collar 5 fits over flange 37 of nipple 3 and screws onto base member 7 with cutout 51 tightly fitting onto said flange 37 to secure the nipple 3 and render it sealed (leakproof). Table 1 below illustrates only some of the many uses for cap 1.

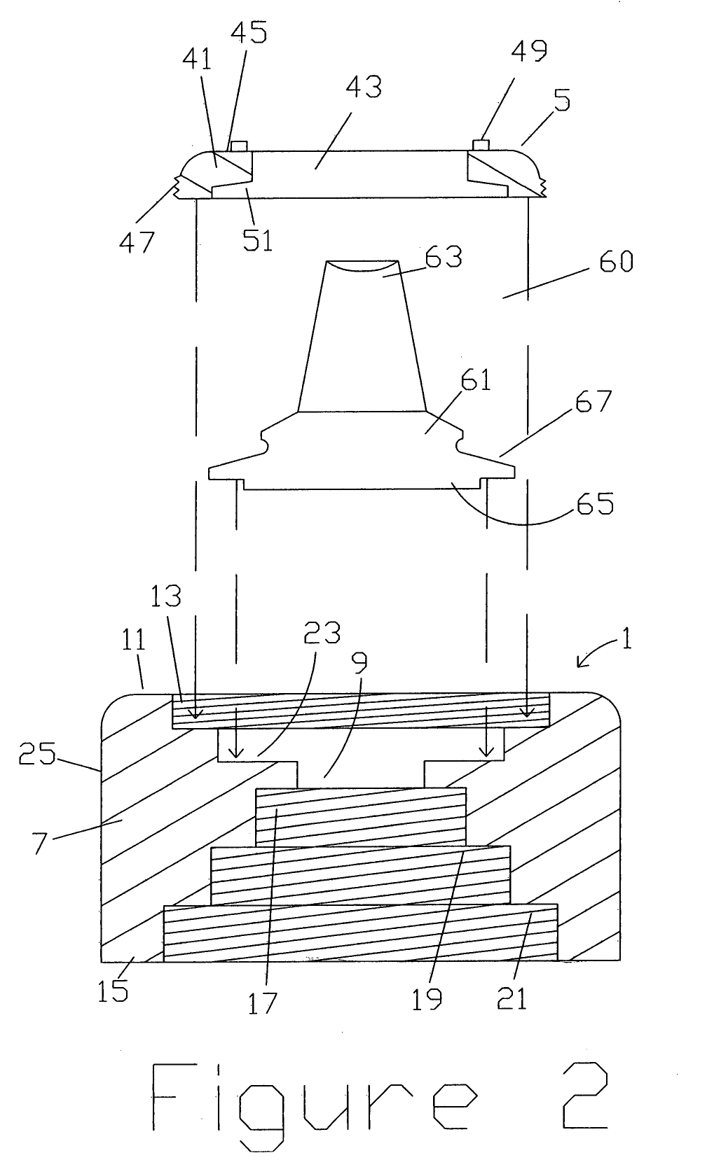

FIG. 2 is a front exploded cut view of one embodiment of the present invention multifunctional bottle cap 2. The ring collar 5 and the base member 7 are the same components as shown in FIG. 1 and like elements are identically numbered. The details are the same as are the functionalities of these like elements, and, thus, are not repeated here. Instead of a flexible nipple, this embodiment includes a drinking spout dispenser 60. Drinking spout 60 has a non-flexible, but optionally foldable (hinged) spout neck 63, and a base 61 with flange 67 and bottom 65. It is attached to the base member 7 with attachment ring collar 5 in the same manner as nipple 3 described in conjunction with FIG. 1 above. Likewise, Table 1 below illustrates only some of the many uses for cap 2.

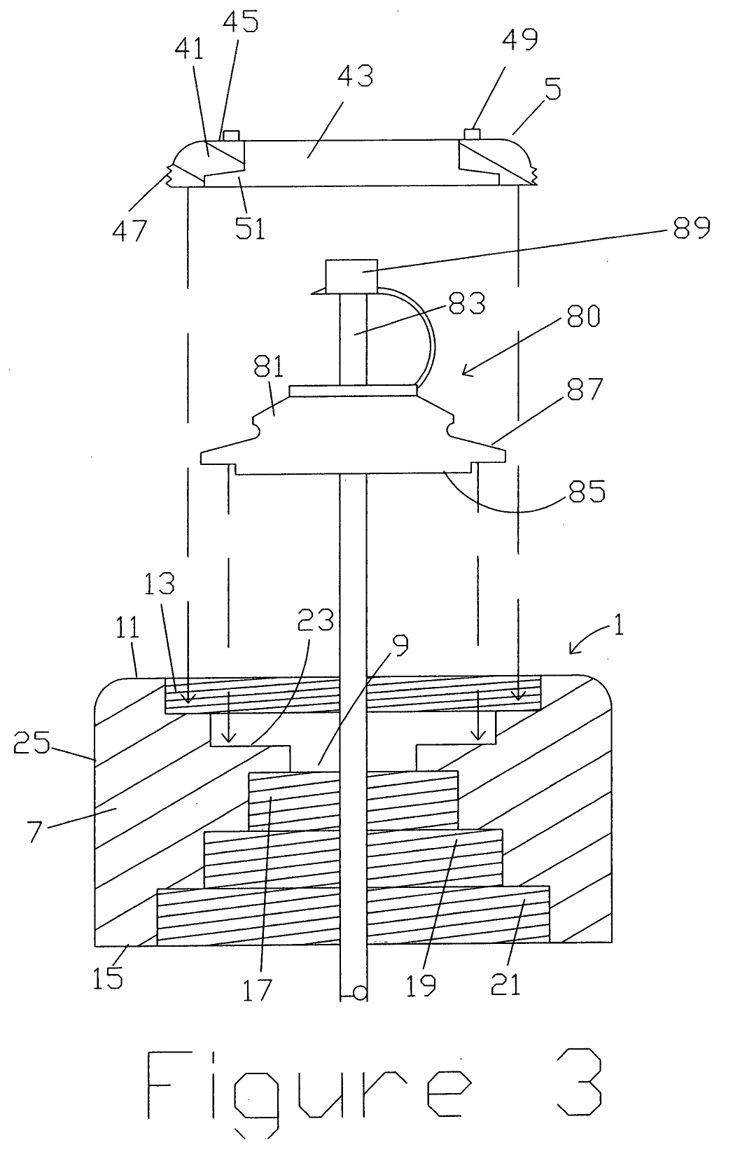

FIG. 3 is a front exploded cut view of one embodiment of the present invention multifunctional bottle cap 4. The ring collar 5 and the base member 7 are the same components as shown in FIG. 1 and like elements are identically numbered. The details are the same as are the functionalities of these like elements, and, thus, are not repeated here. Instead of a flexible nipple or a spout, this embodiment includes a drinking straw 80. Drinking straw 80 includes a sealing neck member 81 with a bottom 85 and a flange 78. It is attached to base member 7 in the same manner as nipple 3 in FIG. 1 above. Straw 80 has a cap 89 with optional tether, as shown. Table 1 below illustrates only some of the many uses for cap 4.

Table 1 illustrates some possibilities for present invention caps based on three different diameters and based on current commercial products:

TABLE 1
PRODUCT USES FOR THREE DIAMETER PRESENT INVENTION CAPS

| Smallest Inside Diameter | Midsize Inside Diameter | Largest Inside Diameter |
|---|---|---|
| Poland Spring Water (23 mm) | Hershey's Milk (34 mm) | Gatorade, large (40 mm) |
| Desari Water (23 mm) | Nestle's Milk (34 mm) | Gerber Juice (37 mm) |
| Gatorade, etc., small (28 mm) | Welch's Juice, etc.(35 mm) | Vitamin Drink (40 mm) |

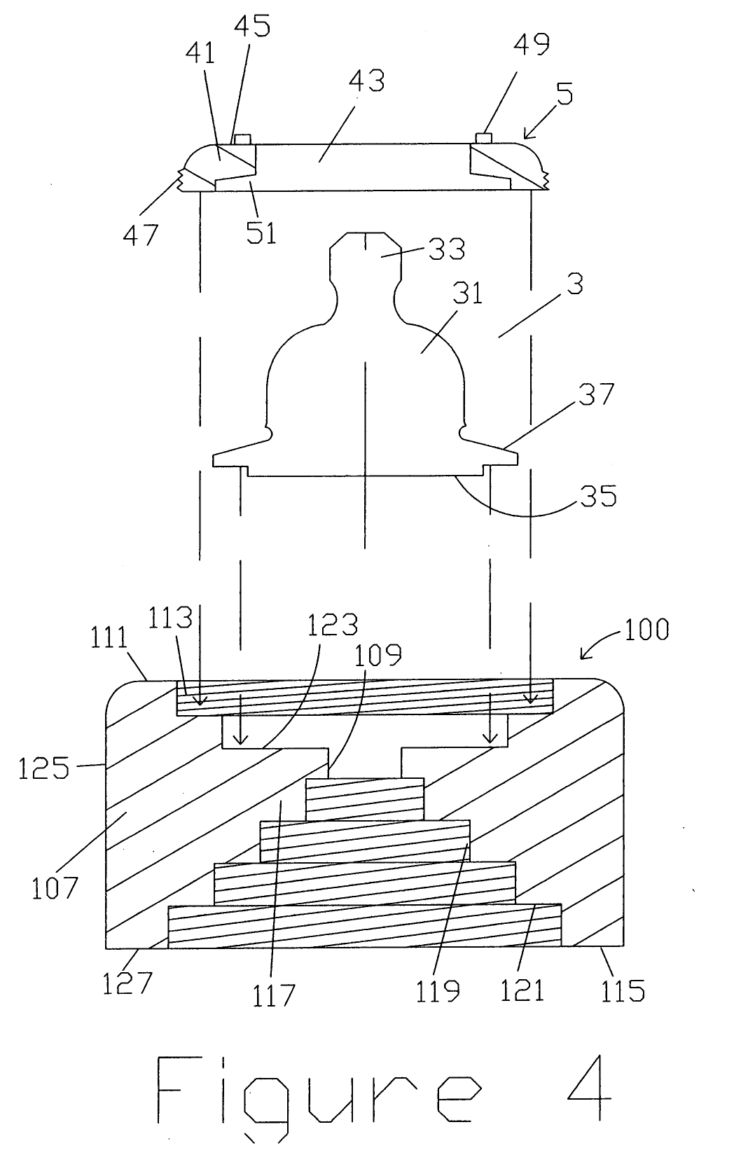

FIG. 4 is a front exploded cut view of one embodiment of the present invention multifunctional bottle cap 100 that includes a base member 107, a flexible baby bottle nipple 3 and an attachment ring collar 5. The base member 107 has a top 111, a bottom 115 and a sidewall 125, as shown. It is circular in external shape, but could have any desired external shape. Its top 111 includes a threaded upper recess 113 adapted to mate with ring collar 5. Top 111 also includes a lower recess 123 adapted to receive flexible nipple 3. Base member 107 also has a dispensing orifice 109 that extends downwardly through bottom 115 and upwardly through the aforesaid recesses. Base member 107 has four different size threaded inside diameters in its bottom 115 to accommodate four different size caps, and hence, has smallest diameter 117 furthest away from bottom 15, next is the second smallest diameter 119, next is the second largest diameter 121, followed by largest diameter 127 closest to bottom 115. By this arrangement, cap 100 may be attached to different size bottles and used for feeding a baby such liquids as containerized milk, water, juice, fruit drinks, fortified liquids and the like, without transferring contents to a baby bottle.

Attachment ring collar 5 has a central orifice 43 passing therethrough, threads 47 on outside wall 41 that screw into the corresponding receiving threads at recess 13 of base member 7. Tabs such as tab 49 on ring collar top 45 facilitate screwing and unscrewing thereof relative to base member 7. The flexible baby bottle-type nipple 3 has a main hollow body 31 with slitted dispensing end 33, and it has a flange 37. Nipple bottom 35 nests in recess 23 of base member 7, ring collar 5 fits over flange 37 of nipple 3 and screws onto base member 7 with cutout 51 tightly fitting onto said flange 37 to secure the nipple 3 and render it sealed (leakproof). Table 2 below illustrates only some of the many uses for cap 100.

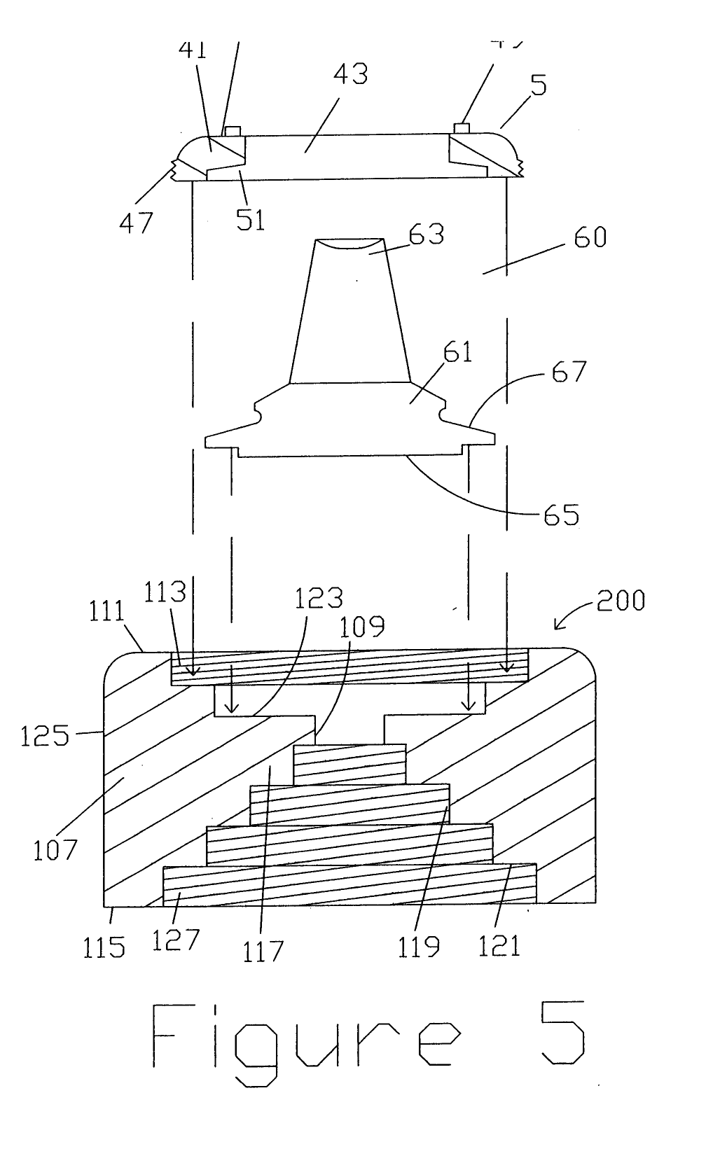

FIG. 5 is a front exploded cut view of one embodiment of the present invention device cap 200. The ring collar 5 and the base member 107 are the same components as shown in FIG. 4 and like elements are identically numbered. The details are the same as are the functionalities of these like elements, and, thus, are not repeated here. Instead of a flexible nipple, this embodiment includes a drinking spout dispenser 60. Drinking spout 60 has a non-flexible, but optionally foldable (hinged) spout neck 63, and a base 61 with flange 67 and bottom 65. It is attached to the base member 107 with attachment ring collar 5 in the same manner as nipple 3 described in conjunction with FIG. 1 above. Likewise, Table 2 below illustrates only some of the many uses for cap 200.

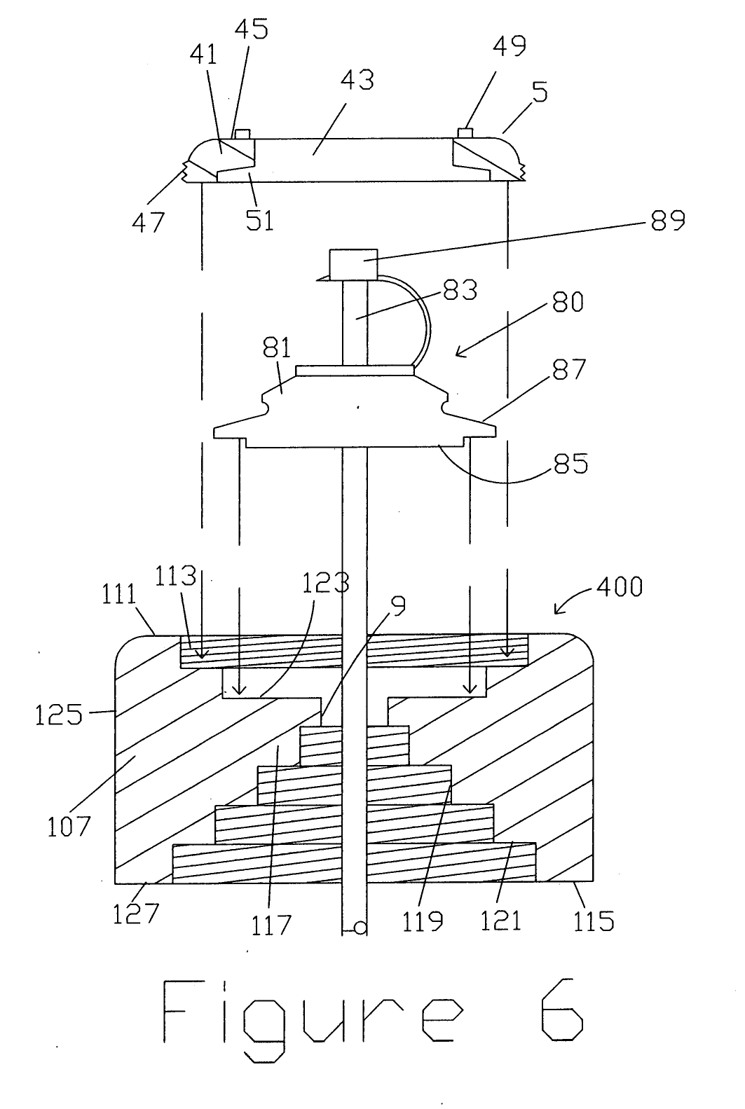

FIG. 6 is a side cut view of one embodiment of the present invention device cap 400. The ring collar 5 and the base member 107 are the same components as shown in FIG. 4 and like elements are identically numbered. The details are the same as are the functionalities of these like elements, and, thus, are not repeated here. Instead of a flexible nipple or a spout, this embodiment includes a drinking straw 80. Drinking straw 80 includes a sealing neck member 81 with a bottom 85 and a flange 78. It is attached to base member 7 in the same manner as nipple 3 in FIG. 1 above. Straw 80 has a cap 89 with optional tether, as shown. Table 2 below illustrates only some of the many uses for cap 400.

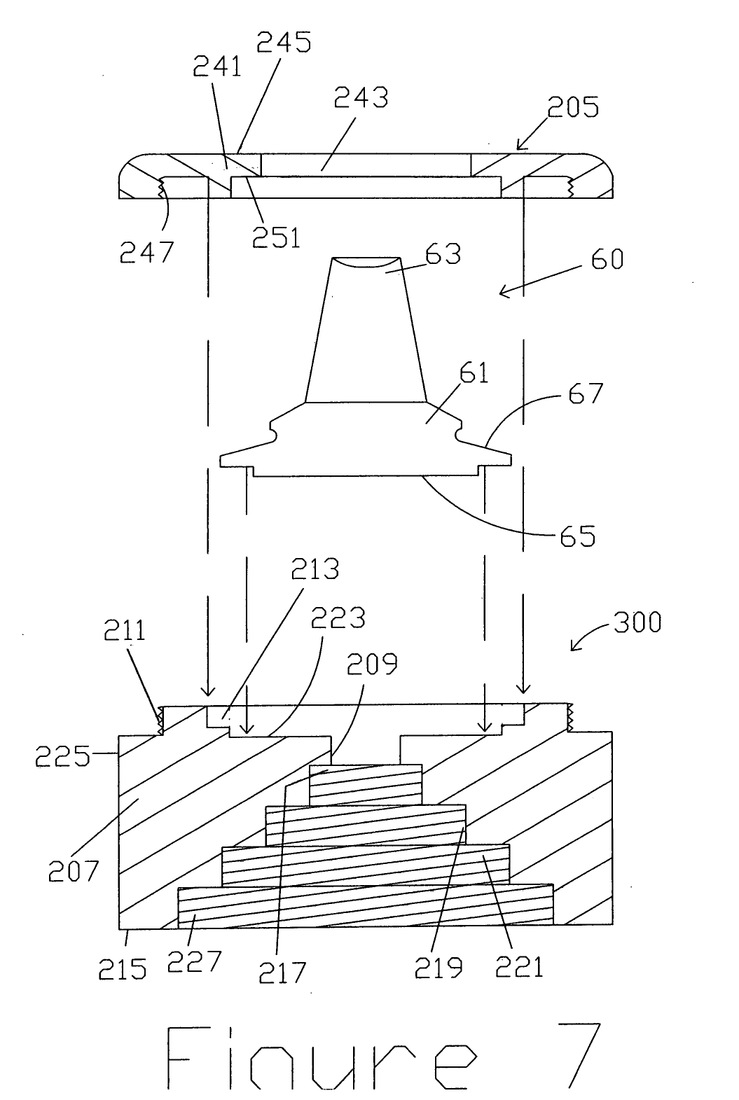

FIG. 7 is a front exploded cut view of one embodiment of the present invention device cap 300. The ring collar 205 is different from the preceding ring collars in that it screws onto the outside of the base member 207 and the base member 207 has external instead of internal threading for the ring collar. There is a drinking spout dispenser 60, sometimes referred to as a “sippy spout”, that is identical to the drinking spout dispenser 60 of FIG. 5 above. Drinking spout 60 has a non-flexible, but optionally foldable (hinged) spout neck 63, and a base 61 with flange 67 and bottom 65. It is attached to the base member 207 with attachment ring collar 205 by being placing the dispenser 60 in recess 223 and on ledge 213, and then screwing ring collar 205 onto base member 207. Internal threads 247 on ring collar 205 connect with external threads 211 of base member 207. Instead of a drinking spout dispenser, a nipple or a straw such as are shown above, could be used here. Ring collar 205 has a top 245 with an opening 243 therethrough for encompassing the dispenser 60 while permitting the spout neck 63 to extend therefrom. It also has a compression ledge 251 that will seal the dispenser 60 tightly when assembled.

Base member 207 has a circular sidewall 225, threads 211, dispensing orifice 209, and four sets of different inside diameter threads 217, 219, 221 and 227 that increase, view from top to bottom, so as to accommodate four different size containers. Table 2 below illustrates only some of the many uses for cap 300.

TABLE 2
PRODUCT USES FOR FOUR DIAMETER PRESENT INVENTION CAPS

| Smallest Inside Dia. | Smaller Mid I. Dia. | Larger Mid I.Dia. | Largest Inside Dia. |
|---|---|---|---|
| Poland Spring Water | Hershey's Milk | Tropicana Juice | Gatorade, large |
| (23 mm) | (34 mm) | (35 mm) | (40 mm) |
| Desari Water | Gatorade, small | Gerber Juice | Gatorade, large |
| (23 mm) | (28 mm) | (37 mm) | (40 mm) |
| Bottled water | Gatorade, etc., | Welch's Juice, | Vitamin Drink |
| (23 mm) small | (28 mm) | Minute Maid(35 mm) | (40 mm) |

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A multifunctional drinking bottle cap for attachment to a plurality of different sized bottle neck diameters, which comprises:
a.) a base member having a top and a bottom and at least one side wall, said base member having a dispensing orifice for dispensing a liquid from a bottle, said bottom having a plurality of concentric threaded orifice sections with sequentially decreasing diameters when measured from said bottom to said top, said top having a flexible nipple connection means and an attachment ring collar connection means;
b.) a flexible nipple for connection to said nipple connection means;
c.) an attachment ring collar adaptable to fit over said flexible nipple and to attach to said attachment means for secured connection of said flexible nipple to said base member.

2. The multifunctional drinking bottle cap for attachment to a plurality of different sized bottle neck diameters of claim 1 wherein said attachment ring collar connection means is a threaded circular boss on said top of said base member and said attachment ring collar has complementary internal threads.

3. The multifunctional drinking bottle cap for attachment to a plurality of different sized bottle neck diameters of claim 1 wherein said attachment ring collar connection means is a snap-on connection means adapted to receive said attachment collar ring by snap fit thereto.

4. The multifunctional drinking bottle cap for attachment to a plurality of different sized bottle neck diameters of claim 1 wherein said base member has two concentric threaded orifice sections.

5. The multifunctional drinking bottle cap for attachment to a plurality of different sized bottle neck diameters of claim 1 wherein said base member has at least three concentric threaded orifice sections.

6. The multifunctional drinking bottle cap for attachment to a plurality of different sized bottle neck diameters of claim 1 wherein said base member and said attachment ring collar are made of plastic material.

7. A multifunctional drinking bottle cap for attachment to a plurality of different sized bottle neck diameters, which comprises:
a.) a base member having a top and a bottom and at least one side wall, said base member having a dispensing orifice for dispensing a liquid from a bottle, said bottom having a plurality of concentric threaded orifice sections with sequentially decreasing diameters when measured from said bottom to said top, said top having a spout connection means and an attachment ring collar connection means;
b.) a spout for connection to said spout connection means;
c.) an attachment ring collar adaptable to fit over said spout and to attach to said attachment means for secured connection of said spout to said base member.

8. The multifunctional drinking bottle cap for attachment to a plurality of different sized bottle neck diameters of claim 7 wherein said attachment ring collar connection means is a threaded circular boss on said top of said base member and said attachment ring collar has complementary internal threads.

9. The multifunctional drinking bottle cap for attachment to a plurality of different sized bottle neck diameters of claim 7 wherein said attachment ring collar connection means is a snap-on connection means adapted to receive said attachment collar ring by snap fit thereto.

10. The multifunctional drinking bottle cap for attachment to a plurality of different sized bottle neck diameters of claim 7 wherein said base member has two concentric threaded orifice sections.

11. The multifunctional drinking bottle cap for attachment to a plurality of different sized bottle neck diameters of claim 7 wherein said base member has at least three concentric threaded orifice sections.

12. The multifunctional drinking bottle cap for attachment to a plurality of different sized bottle neck diameters of claim 7 wherein said base member and said attachment ring collar are made of plastic material.

13. The multifunctional drinking bottle cap for attachment to a plurality of different sized bottle neck diameters of claim 7 wherein said spout is made of plastic material.

14. A multifunctional drinking bottle cap for attachment to a plurality of different sized bottle neck diameters, which comprises:
a.) a base member having a top and a bottom and at least one side wall, said base member having a dispensing orifice for dispensing a liquid from a bottle, said bottom having a plurality of concentric threaded orifice sections with sequentially decreasing diameters when measured from said bottom to said top, said top having a straw connection means and an attachment ring collar connection means;
b.) a straw for connection to said straw connection means;
c.) an attachment ring collar adaptable to fit over said straw and to attach to said attachment means for secured connection of said straw to said base member.

15. The multifunctional drinking bottle cap for attachment to a plurality of different sized bottle neck diameters of claim 14 wherein said attachment ring collar connection means is a threaded circular boss on said top of said base member and said attachment ring collar has complementary internal threads.

16. The multifunctional drinking bottle cap for attachment to a plurality of different sized bottle neck diameters of claim 14 wherein said attachment ring collar connection means is a snap-on connection means adapted to receive said attachment collar ring by snap fit thereto.

17. The multifunctional drinking bottle cap for attachment to a plurality of different sized bottle neck diameters of claim 14 wherein said base member has two concentric threaded orifice sections.

18. The multifunctional drinking bottle cap for attachment to a plurality of different sized bottle neck diameters of claim 14 wherein said base member has at least three concentric threaded orifice sections.

19. The multifunctional drinking bottle cap for attachment to a plurality of different sized bottle neck diameters of claim 14 wherein said base member and said attachment ring collar are made of plastic material.

20. The multifunctional drinking bottle cap for attachment to a plurality of different sized bottle neck diameters of claim 14 wherein said rigid nipple is made of plastic material.
